(19) United States
(12) Patent Application Publication
(10) Pub. No.: US 2014/0100857 A1
(43) Pub. Date: Apr. 10, 2014

(54) SYSTEM AND A METHOD FOR PREAUTHORIZATION FOR PAYMENT FROM PATIENT

(71) Applicants: Rajesh Srinivas Toleti, (US); Chakri Toleti, (US); Nageshwara Rao Vempaty, (US)

(72) Inventors: Rajesh Srinivas Toleti, (US); Chakri Toleti, (US); Nageshwara Rao Vempaty, (US)

(73) Assignee: Greatwater Software Inc., Orlando, FL (US)

(21) Appl. No.: 13/316,982

(22) Filed: Dec. 12, 2011

(51) Int. Cl. G06F 19/00

(52) U.S. Cl. CPC G06F 19/328
USPC 705/2

(57) ABSTRACT

Systems and methods for collecting preauthorization payments from a patient are disclosed. One example system includes a kiosk, a server and a real time healthcare preauthorization management tool for computing or estimating the patient portion for a healthcare service at a time of a patient encounter based on one or more of eligibility, services, plan, payer or some combination of these.

### REFERENCES CITED

1. “System and methods for medical services and transactions” Edward W. Knowlton, U.S. Pat. Application 2004/0172291 A1—Filed Jul. 25, 2003
2. “Electronic creation, submission, adjudication, and payment of health insurance claims”

Peterson et. al., U.S. Pat. No. 6,343,271—Filed Jul. 17, 1998—P5 e.Health Services, Inc.

A system and a method for collecting preauthorization payment from patient are disclosed in the context of healthcare industry. This invention can be applied prior, during or post encounter between a patient and a provider for healthcare services. Currently several healthcare providers in the United States of America do not collect a preauthorization amount from a patient. They often collect a preauthorization consent form (which is a blanket promise to pay) but not a preauthorized payment by conducting a financial transaction with, for example, a credit card processor. The reasons may be lack of information on the amount to collect at the point of time in consideration, the lack of an estimate of amounts to be charged to the patient, the need to collect payment from a third party payer first, the lack of technical capability, the convenience in the patient's perspective, and several more. Our notion of collection of preauthorization obligation as a financial transaction before a patient leaves a healthcare provider is a disruptive concept. In the preferred embodiment, the system includes a kiosk or several kiosks or a clipboard tablet or several clipboard tablets or a mobile device or several mobile devices or a computer or several computers or any combination thereof to interact with the patient, a server to manage the said interaction, a computing device or several computing devices or terminal(s) for the provider and/or provider staff, and a backend real time healthcare preauthorization management software. The method in our invention works by computing or estimating the patients portion of payment by looking at the said patient's appointment, eligibility, service(s), plan(s), payer(s), etc., in the context of the episode of care, and also backend practice management system(s) and other backend healthcare IT systems. This estimate is presented appropriately to the patient at the patient touch point. The patient touch point may occur on a variety of devices, including a kiosk, a portal page, a mobile device or a computer. The patient touch point may occur before the encounter, during the encounter or after the encounter. There may be multiple patient touch points on the time line on the same or on different devices. The preauthorization form with estimated amount is presented to the patient at the touch point; the patient's credential(s) such as a signature is captured, appropriate forms are generated and filled interactively with the patient and the financial transaction for monetary consideration preauthorized by the patient is then processed by the server software. The processing can be customized by context to electronically document and file the preauthorization. The processing can be customized to enable various modes of electronic transactions for capturing the preauthorized consideration amount in real time or near real time. The results of the transaction can optionally be presented appropriately as a preauthorization receipt to the patient. Our invention enables collecting the preauthorization for patient's portion of payment for healthcare services rendered at the point of care before, during or after an encounter. It disruptively changes the current state of art in healthcare industry where the providers are unable to conduct a monetary preauthorization transaction for various reasons during the encounter; instead they a get a blanket preauthorization document signed with consent to bill the patient later. The collection of the patient portion in this case may be delayed by several minutes to several days or even months post encounter. The primary benefits of our invention include the enabling the provider to present the patient a better picture of their out of pocket expenses for the episode of care, the ability to utilize the preauthorization before, during or after the said encounter to collect the patient portion of the payment faster, with fewer errors or delays, and even electronically on modern financial infrastructure. Our invention can reduce the days outstanding for collection of patient's portion of obligation by healthcare providers.

### SUMMARY OF THE INVENTION

Our invention consists of a system and a method for obtaining a preauthorization from a patient for the patient's part obligation of healthcare payment before, during or after a patient encounter with a healthcare provider. The currently prevalent practice is to collect a blanket pre-authorization form signed by the patient and billing the patient later. The origin of this process is due to historical changes in healthcare industry in the United States. The collection of patient portion of the bill is time consuming and involves manual paper based processes. The current process can take several days before a bill is generated and sent to the patient. Our invention replaces this with an electronic network and a semi automated process, where the preauthorized amount can be collected before, during or after the patient's encounter as appropriate. It enables the provider with the option of collecting the patient's obligation during the encounter if desired. The preauthorized amount can be used to completely or partially clear the financial obligation of the patient when a fund collection is made using the preauthorization. The system consists of a kiosk or a network of several kiosks or a handheld device or several handheld devices, and associated software. The method consists of enabling the provider present an estimate of the patient's portion of obligation based on the context of the encounter and enabling the patient to conduct a preauthorization transaction. The preauthorization is posted to the providers billing system and is used when the bill for the patient's portion of obligation is generated. Either the whole bill or a portion of the bill is marked as paid for the consideration already preauthorized. Our invention increases the efficiency and reduces the collection time for healthcare providers in getting payments from the patients.

### BACKGROUND

Collecting payments on healthcare claims is time consuming and costly. In the typical paper driven manual processes currently in vogue, the amount of the patient's obligation is not known until after the completion of the episode, the adjudication of claims made and payment receipt from payer. During the encounter, the provider accumulates the details of services and goods provided in a super bill which is then used to generate claim(s). The creation of the claim itself can take several days. The claim(s) is then submitted to the payer or multiple payers if appropriate for adjudication. Several payers support electronic means for submitting claims. The payer adjudicates the claim and returns an explanation of benefits and a payment to the provider. The two may happen separately, electronically or manually, and can take several days or weeks. The EDI standard in the United States for submitting a claim is ANSI X12 837 and for receiving the explanation of benefits (EOB) is ANSI X12 835. The provider then figures the difference in payment received and calculates the payment that needs to be collected from the patient. This is then submitted to the patient along with relevant EOB, typically on paper, requesting a payment. Afterwards, the patient may send a payment to the provider. In the United States, there are often complications and confusions resulting from multiple payers, from per incident and annual deductibles associated with healthcare plans, and from eligibility and order of precedence associated with healthcare plans. The process of computing the patient portion of obligation can potentially take several days or several months. This extends the collection time into several days or months for the provider and is error prone. It is also well known in the industry that a percentage of the patient obligation becomes uncollectable due to delays. It is desirable to automate the process and speed up the day sales outstanding from the provider's point of view for collecting the portion of payment owed by the patient.

### BRIEF DESCRIPTION OF THE DRAWINGS

FIG. 1 illustrates one specific embodiment of our invention, where the preauthorization transaction for the estimated amount of patient obligation is collected from the patient along with the agreement to pay any further cost overruns beyond the preauthorized amount using a kiosk.

FIG. 2 illustrates the method by means of a flow chart a method for collecting the patient's portion of payment obligation.

### DETAILED DESCRIPTION OF THE PREFERRED EMBODIMENTS

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The preferred embodiment of the invention will now be described with reference to the figures in which like numbers correspond to like references throughout.

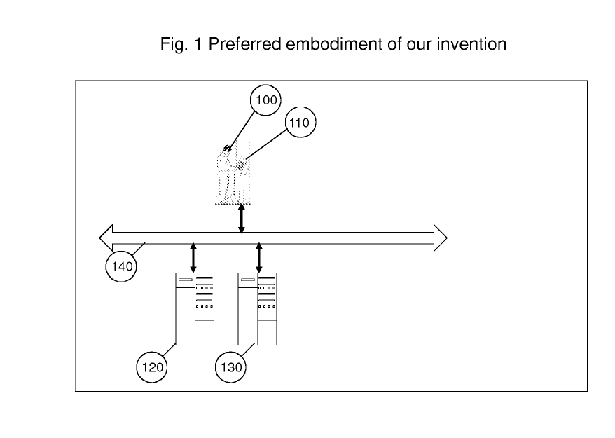

In FIG. 1, patient 100 goes to a provider office where he/she is greeted by a self service kiosk 110. The kiosk 110 is connected by means of computer network 140 to scheduling system 120 and practice management system 130. After identifying the patient and the patient's appointment, our system estimates the amount of payment due from the patient for the encounter. This is presented to the patient on kiosk 110 and the patient is offered choices of payment modes such as credit, debit, cash, check, etc. The amount collected is posted to the backend practice management system 130. Optionally, the kiosk may also present a customized preauthorization form and capture the patient's agreement to pay any further costs, in case the actual exceeds the estimate.

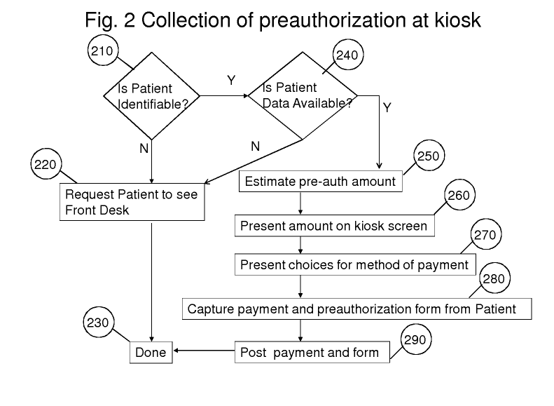

The workflow of the preauthorization collection is presented in FIG. 2. In step 210, patient identification is performed using a combination of factors. If the patient cannot be positively identified, he/she is referred to the front desk in step 220 and the processing is completed in step 230. If the patient is positively identified in step 210, then the details of the patient's appointment and patient data are looked up in step 240. If they are not available the patient is referred to the front desk in step 220. If the data is available, then the amount to be charged to the patient for the encounter is estimated in step 250, based on the type of appointment, the payer, co-pay, etc. (If a payer supports real time adjudication and if a claim is submitted in real time during the encounter and if the preauthorization collection functionality is enabled in a checkout kiosk, then the results of the adjudication are parsed to obtain this amount.) This is presented to the patient in step 260 and the payment options supported by the kiosk are presented in step 270. They may include one or more of credit, debit, check, cash, PayPal, a Bill-Me-Later type of service, etc. The amount paid by the patient is captured in step 280 and also as an optional safety, a preauthorization agreement is obtained from the patient in case the actual amount exceeds the amount collected, in step 280. The preauthorization agreement and the transaction are posted to backend system(s) in step 290. Also, the receipt for the captured amount may be presented to the patient printed on paper or by email or by text messaging (SMS) or by multimedia messaging service (MMS) in step 280. The processing is completed in step 230.

We described specific embodiments of the invention along with specific examples in the specific domain of healthcare. Practitioners of the art can apply our invention to several other examples that may differ in several ways from the examples we discussed, including but not limited to the type of encounter, the details of the information available, etc. Practitioners of the art can derive several embodiments and domains of applicability of our invention. An alternate embodiment of the invention may not use a kiosk. Yet another alternate embodiment of the invention may utilize one or a plurality of mobile devices in place of or in addition to kiosk(s). Yet another alternate embodiment of our invention may implement the preauthorization collection at a check out kiosk, towards the end of the encounter. Yet another alternate embodiment of the invention may not use a backend IT system or may use one or more backend IT systems and/or other systems. Practitioners of the art can apply our invention to such alternate embodiments also.

The illustrations, and block diagrams of FIGS. 1 and 2 illustrate the architecture, functionality, and operation of possible implementations of apparatus, systems, methods and computer program products according to various embodiments of the present invention. In this regard, each block in the flow charts or block diagrams may represent a module, electronic component, segment, or portion of code, which comprises one or more executable instructions for implementing the specified function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be understood that each block of the block diagrams and/or flowchart illustrations, and combinations of blocks in the block diagrams and/or flowchart illustrations, can be implemented by special purpose hardware-based systems which perform the specified functions or acts, or combinations of special purpose hardware and computer instructions.

In the drawings and specification, there have been disclosed typical illustrative embodiments of the invention and, although specific terms are employed, they are used in a generic and descriptive sense only and not for purposes of limitation, the scope of the invention being set forth in the following claims.

### NOTE REGARDING CLAIMS

In the discussions contained in this Patent Application we have included many major elements which obviously are bases for claims as we technically understand them. In addition, as is customary practice, we request that the Patent Examiner point out any resulting claims we may have inadvertently missed, and that he/she point out any relevant changes that should be made to clarify the submitted claims, and that he/she point out any unintended duplication of claims should such inadvertently occur.

What is claimed is:

1. A system and a method for collection of preauthorization of payment from a patient in which the amount preauthorized may be collected before, during or after an encounter with a provider, where the system consists of one or more kiosks, mobile devices, computers and the method consists of computing the preauthorization amount based on the patient's eligibility, the encounter and the payers involved, and presenting the amount to the patient to obtain a preauthorization document and/or amount.

2. A system of claim 1, where the preauthorization is presented to the patient at a kiosk.

3. A system of claim 1, where the preauthorization is presented to the patient at a mobile device.

4. A method of claim 1, where the patient's signature on a preauthorization document is obtained.

5. A method of claim 1, where a copy of the preauthorization form is emailed to the patient.

6. A method of claim 1, where the preauthorization amount is collected from the patient by means of a credit card, debit card, benefits card, check, cash, store value card, PayPal or combinations thereof.

7. A method of claim 1, where the preauthorization amount is deferred to a collection plan, payment in one or more installments or a Bill-Me-Later type of service.

8. A method of claim 1, where an authorization to collect payment and/or the actual collection of payment is done for past due bills of the patient.

9. A method of claim 1, where the amount obtained in preauthorization from the patient is posted to a backend accounting system of the provider.

10. A method of claim 1, where costs beyond the amount preauthorized are collected later from a patient by sending a bill or during the next encounter.
